(19) United States
(12) Patent Application Publication
(10) Pub. No.: US 2016/0217718 A1
(43) Pub. Date: Jul. 28, 2016

(54) ILLUMINATED PRODUCT AND METHOD FOR COORDINATING THE LOCATION OF ATTENDEES AT AN EVENT

(71) Applicant: Travis Silver, Asheville, NC (US)

(72) Inventor: Travis Silver, Asheville, NC (US)

(21) Appl. No.: 14/602,527

(22) Filed: Jan. 22, 2015

(51) Int. Cl. G09F 13/18; G06Q 10/02; G09F 13/22

(52) U.S. Cl. CPC G09F 13/18; G09F 13/22; G06Q 10/02; G09F 2013/1877; G09F 2013/184; G09F 2013/222

(57) ABSTRACT

There is provided an illuminated product including a foot element, a view mounting element, a housing containing a light source, and an interchangeable indicia carrier. There is also provided a method for coordinating a preferred occupant plan with a plurality of floor spot indicia carriers. The floor spot indicia carrier can be an illuminated product.

### BACKGROUND OF THE INVENTION

Arranging guest seating at an event can play a pivotal role in helping or hindering the success of the event. For example, at an event such as a wedding, it is frequently desired to accommodate guests of the families of the bride and the groom, or to accommodate friends, such groups of similar guests are seated at the same table or at nearby tables. Also, the serving of meals prepared according to special diets requires that the food servers accurately deliver the special meals to the right guest and so an accurate guest seating chart is essential to performing this task. Moreover, it would be beneficial to optimize the coordination between the guest seating chart and the directional signs, name badges, and other physical items that are deployed on tables and the like to guide the guests to the desired seating.

As an example of the detailed coordination required by some events, event planners at weddings may desire to seat the bride and groom at a head or main table in the front of the room, and then place members of the wedding party (best man, maid of honor, etc.) in close proximity to the bride and groom. Guests at the wedding can be divided into small groups and organized to occupy the general population of tables and place settings. The arrangement of the guests and neighboring guests can be a difficult and time consuming task, requiring numerous revisions and involving the input and consideration of two or more families, event planners and a host of other interested parties.

The process of organizing a seating preference chart can reveal to event organizers which table arrangements are not workable. The size of tables, the types of table geometries, and the proximity of tables to a dance floor or music broadcast area need to be taken into account in order to arrive at a preferred room layout and event-seating chart to meet individual preferences, and to comply with applicable laws. Perfecting a room layout with seating chart can involve a significant amount of time, require numerous revisions, and extensive trial placement iteration.

One well-known method of creating seating charts for an event involves the creation and manipulation of a list of guests written on a piece of paper.

U.S. Pat. No. 6,070,347 to Hergott discloses a frame for visually displaying indicia for identifying the location of the frame. The frame mountable identifying device 10 is configured to be attached to a chair at, for example, a stadium or an auditorium and includes identifying indicia 21 that can indicate, for example, a set row number and a seat number. Although the frame mountable identifying device disclosed in U.S. Pat. No. 6,070,347 to Hergott may provide improved visibility in identifying floor spots as compared to a typical seat-mounted tag or sign, the frame mountable identifying device of U.S. Pat. No. 6,070,347 to Hergott is not well suited for other types of floor spot environments such as, for example, an event with seating at tables at which room space and electrical cord power supply is limited.

### SUMMARY OF THE INVENTION

The present invention solves the above-mentioned problems by providing an illuminated product that is specifically adapted to optimize the smooth running of an event at which attendees are requested to sit or be located at a preferred occupancy location during the event or during a portion of the event.

It is one object of the present invention to provide an illuminated product having interchangeable indicia carriers and which can be illuminated to provide a back-lit or light-focused effect.

It is a further object of the present invention to provide a method for deploying illuminated products in a manner which permits convenient last minute changes to the organization of an event at which attendees are requested to locate themselves at a respective designated location within the event venue.

It is yet an additional object of the present invention to provide an illuminated product having an interchangeable indicia carrier that is inscribed with or otherwise formatted with the name of an event attendee and which can be kept by the event attendee as a memento of the event.

It is also an object of the present invention to provide an illuminated product that economically illuminates a graphic element and/or an attendee name in a manner that is eye-catching and which facilitates the task of the event attendees correctly locating the respective floor spot or table seating at which they are asked to be present.

According to further features of the one aspect of the present invention, there is provided an illuminated product including a foot element, a view mounting element, a housing containing a light source, and an interchangeable indicia carrier.

According to another aspect of the present invention, there is provided a method for coordinating a preferred occupant plan with a plurality of floor spot indicia carriers.

The present invention is generally directed towards a convenient and practical illuminated product. The principles of the present invention, however, are not limited to the particular configurations of the an illuminated product described herein. Additionally, to assist in the description of the an illuminated product of the present invention, words such as top, bottom, front, rear, right and left may be used to describe the accompanying figures, which may be but are not necessarily drawn to scale. It will be appreciated that the illuminated product can also be used as a stand-alone device or used in combination with methods for coordinating a preferred occupant plan such as, for example, a table seating chart for an event.

### BRIEF DESCRIPTION OF THE DRAWINGS

Other features and advantages of the invention will become apparent to those skilled in the art, upon review of the following detailed description, claims, and drawings.

FIG. 1 is a top front perspective view of one embodiment of the illuminated interchangeable indicia carrier product of the present invention;

FIG. 2 is a top front perspective view of a further embodiment of the illuminated interchangeable indicia carrier product of the present invention;

FIG. 3 is a front plan schematic view of the method for coordinating a preferred occupant plan with a plurality of floor spot indicia carriers of the present invention;

FIG. 4A is a top perspective view of one change-out customized variation of the interchangeable indicia carrier product bearing the name of a preferred occupant; and

FIG. 4B is a top perspective view of the one change-out customized variation of the interchangeable indicia carrier product shown in FIG. 4A and bearing the name of a different preferred occupant;

FIG. 5A is a top perspective view of one card swap out variation of the interchangeable indicia carrier product bearing the name of a preferred occupant; and

FIG. 5B is a top perspective view of the card swap out variation of the interchangeable indicia carrier product shown in FIG. 5A and bearing the name of a different preferred occupant.

### DETAILED DESCRIPTION OF AN EMBODIMENT

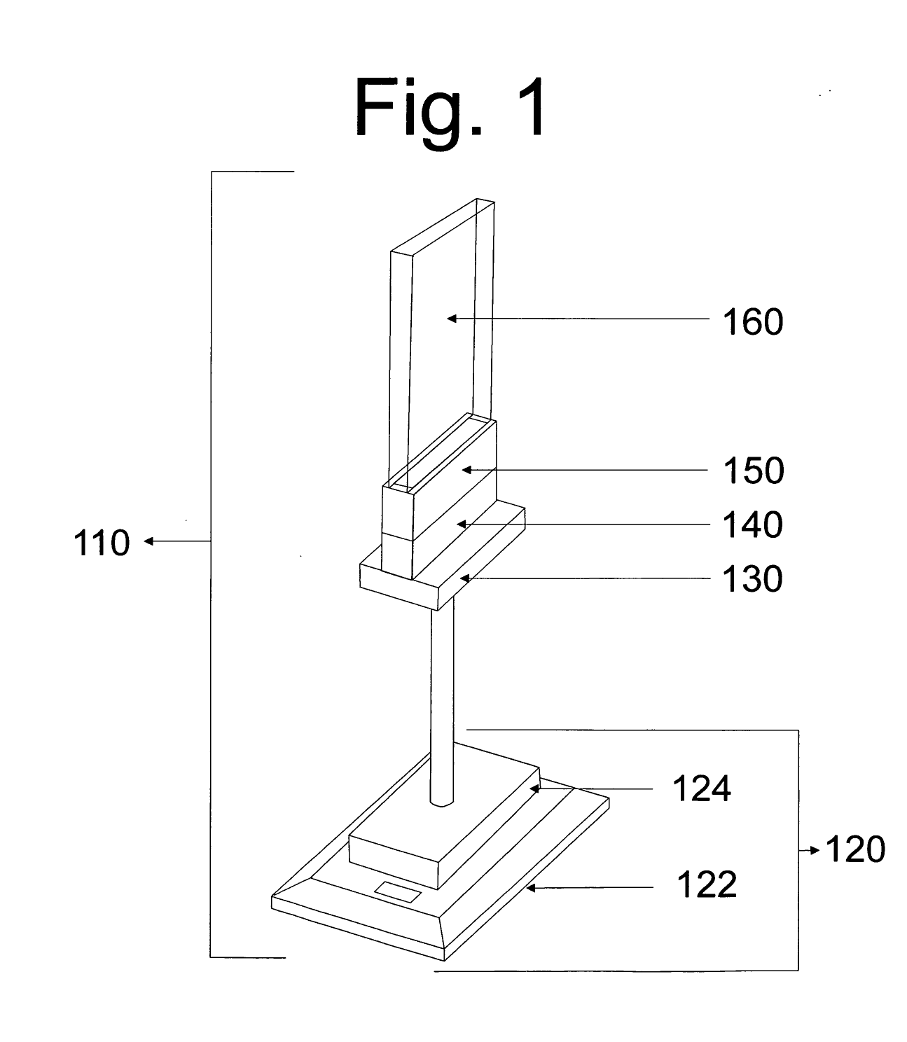

As seen in FIG. 1, which is a top front perspective view of one embodiment of the illuminated interchangeable indicia carrier product of the present invention, the illustrated illuminated interchangeable indicia carrier product is an example of a version of the illuminated interchangeable indicia carrier product in which a light source and a display component of the product are operably interconnected via a light delivery conduit. This version is generally designated as a tall-remote stand product 110 and the tall-remote stand product 110 includes a foot element 120, a housing containing a light source 130, a light delivery conduit 140, a view mounting element 150, and an interchangeable indicia carrier 160.

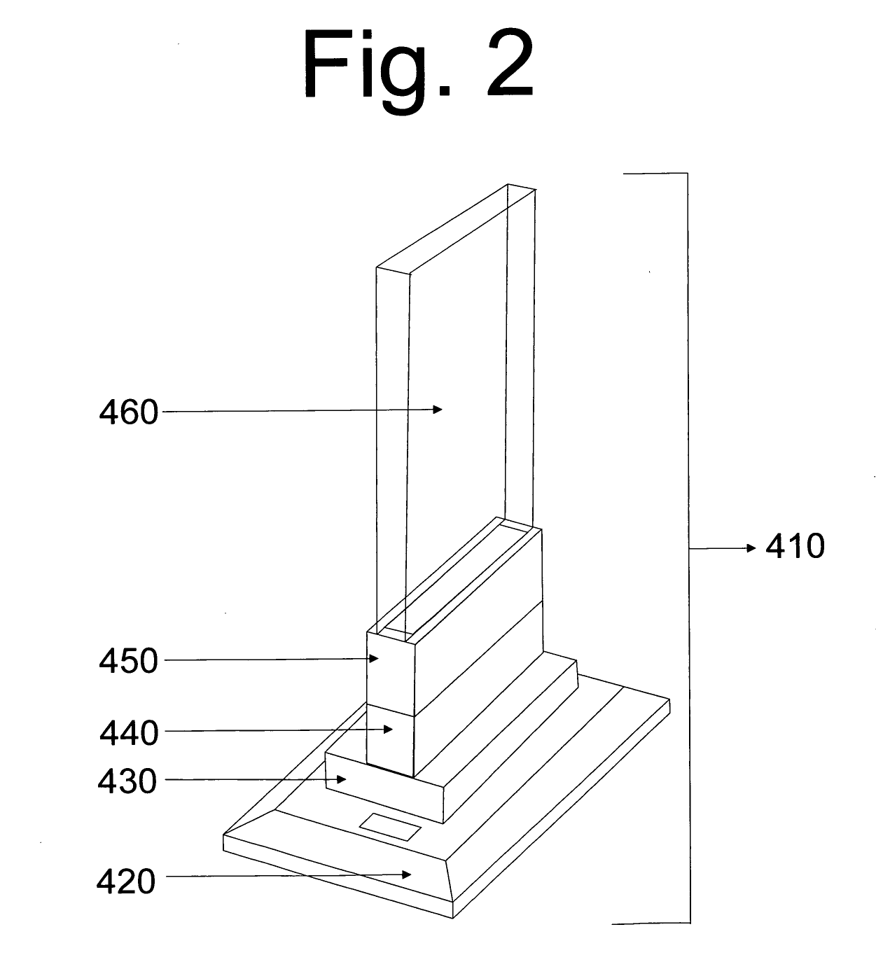

As seen in FIG. 2, which is a top front perspective view of a further embodiment of the illuminated interchangeable indicia carrier product of the present invention, the therein illustrated illuminated interchangeable indicia carrier product is an example of a version of the illuminated interchangeable indicia carrier product in which a light source and a display component of the product are operably interconnected to one another in a closely adjacent manner. This version is generally designated as a short-direct product 410. The tall-remote stand product 110 and the short-direct product 410 are each configured to provide an illuminated indicia display, in coordination with a group of other illuminated indicia products, in connection with an implementation of the method of the present invention.

Turning now to further details of the tall-remote stand product 110, the foot element 120 includes a rectangular base block 122 having a generally planar or flat bottom surface suitable for placement into direct contact with the surface of a table, a shelf, or the like, and the rectangular pedestal block 124 sized in correspondence with the rectangular base block 122 such that the rectangular pedestal block 124 has a proportionally smaller length and width than the rectangular base block 122 and is mounted in a centered location on a top surface of the rectangular base block 122.

The housing containing a light source 130 can be on the a pedestal mounted above the foot element 120 and the foot element 120 may include a power supply such as a battery or an electrical cord to supply power from an electrical outlet to the light source, and a printed circuit board or switch for controlling power supplied to the light source. The housing containing a light source 130 may contain an LED, halogen bulb or other light emitting source and, in the example shown in FIG. 1, the housing containing a light source 130 contains a single LED. The housing containing a light source 130 may include a timing element which causes the indicia carrier to be illuminated or darkened (not illuminated) after a predetermined period of time.

The light delivery conduit 140 extends between the interchangeable indicia carrier 160 and the housing containing a light source 130 and operable to convey light emitted by the light source within the housing containing a light source 130 to a location at which light exiting the light delivery conduit 140 is incident upon the interchangeable indicia carrier 160. The light delivery conduit 140 can be figured as a fiber optic light guide.

The view mounting element 150 includes a stability slot in which the bottom portion of the interchangeable indicia carrier 160 is seated. The interchangeable indicia carrier 160 may be held in the stability slot of the view mounting element 150 via, for example, an adhesive such as glue and/or may be held via a press or friction fit. The view mounting element 150 supports the interchangeable indicia carrier 160 at a preferred viewing orientation—in connection with the one embodiment shown in FIG. 1, the view mounting element 150 supports the interchangeable indicia carrier 160 at a vertical orientation.

The interchangeable indicia carrier 160 is formed of a suitable construction and material onto which indicia, or indicia markers, are present such that light emitted via the light delivery conduit 140, and guided to the interchangeable indicia carrier 160 held by the view mounting element 150, can intersect or be incident upon the indicia or the indicia markers and thereby produce a desired image to be viewed by a person such as an event attendee. A translucent acrylic plate is an example of one such indicia carrier of suitable construction and material and the translucent acrylic plate can be formed of single non-laminated piece of acrylic or of multiple laminates of acrylic. Print font or cursive font wording, as well as non-text or graphic images such as landscapes, flowers, animals, vehicles, and the like, can be etched (via sand blasting, for example), created via ablation performed by a laser, engraved, or otherwise formed on an exterior surface of the translucent acrylic plate or interiorly of the plate.

As desired, various enhancements can be carried out to further highlight the visual effect of the imagery displayed by the interchangeable indicia carrier 160. For example, border darkening or “frosting” effects can be added along edges of the translucent acrylic panel to reflect or otherwise intercept emitted light and re-direct such light, thereby giving an “aura” effect in the immediate area of the edge enhancements. As another example, negative profiles can be provided within the translucent acrylic plate that likewise reflect or otherwise intercept emitted light and re-direct such light, thereby giving an “aura” effect in the immediate area of these profiles.

Turning now to further details of the short-direct product 410, the short-direct product 410 includes a foot element 420, the housing containing a light source 430, a light delivery conduit 440, a view mounting element 450, and an interchangeable indicia carrier 460. In the example shown in FIG. 2, the housing containing a light source 430 includes three LEDs that are spaced from one another and the light delivery conduit 440 is a rectangular opening to direct or allow light to incident upon the interchangeable indicia carrier 460.

The interchangeable indicia carrier 160 or the interchangeable indicia carrier 460 may be configured of any desired shape and may be, for example, planar or flat or bowed and may be ribbed or smooth-surfaced. Additionally, the indicia carrier can be formed of any suitable translucent material such as acrylic or another material providing suitable light-transmitting or light-reflective properties such as plastic or glass. The indicia carrier effectively displays desired letters, figures and symbols in a variety of colors while accomplishing a desired color effect, and offers enhanced light intensity and controllable brightness of the displayed indicia.

The name or other identifying information about the event attendee can be placed on a “name tag” insert via a suitable process such as “micro-dot” printing, or by a silk screen process, or by any other suitable means such as is disclosed in U.S. Pat. No. 4,337,590, wherein The information or legend may be placed on a replaceable thin sheet of synthetic plastics material by “micro-dot” printing, or by a silk screen process, or by any other suitable means.

Solely for the sake of providing one example of a suitable approach to creating an indicia carrier, reference is had to U.S. Pat. No. 6,078,617, which discloses a computer graphic laser etchingsystem that is suitable for creating indicia on the indicia carrier. U.S. Pat. No. 6,078,617 uses a computer controlled high intensity laser to form a number of etch points within a base material such as glass. The material can be a plastic resin having good transparency such as polyethylene, polypropylene, polyvinyl chloride, acrylic resins and the like, and may include acrylic resins such as polymethyl methacrylate and copolymers of methyl methacrylate and methacrylic acid.

The housing containing a light source 130 or the housing containing a light source 430 will contain a preferably suitable version of a light emitting diode (LED), but other light sources are contemplated and within the scope of the invention, including fiber optic lighting, laser, infrared, ultraviolet, fluorescent bulbs, incandescent bulbs, and ambient light. Actuation of the light source may be controlled by a controller which may be powered by batteries within the unit itself or by an external power source. Natural light can also be used to illuminate the display, and may be collected remotely using a focusing lens and transmitted to the display via fiber optics.

A variety of animations, three-dimensional (3D) effects, color fading, color blending may be done without departing from the scope of the invention. Similarly, any type of relief may be used, including, without limitation, seasonal images, corporate trademarks or other logos, illustrations, text, graphics, reliefs of photographs, or any other type of relief.

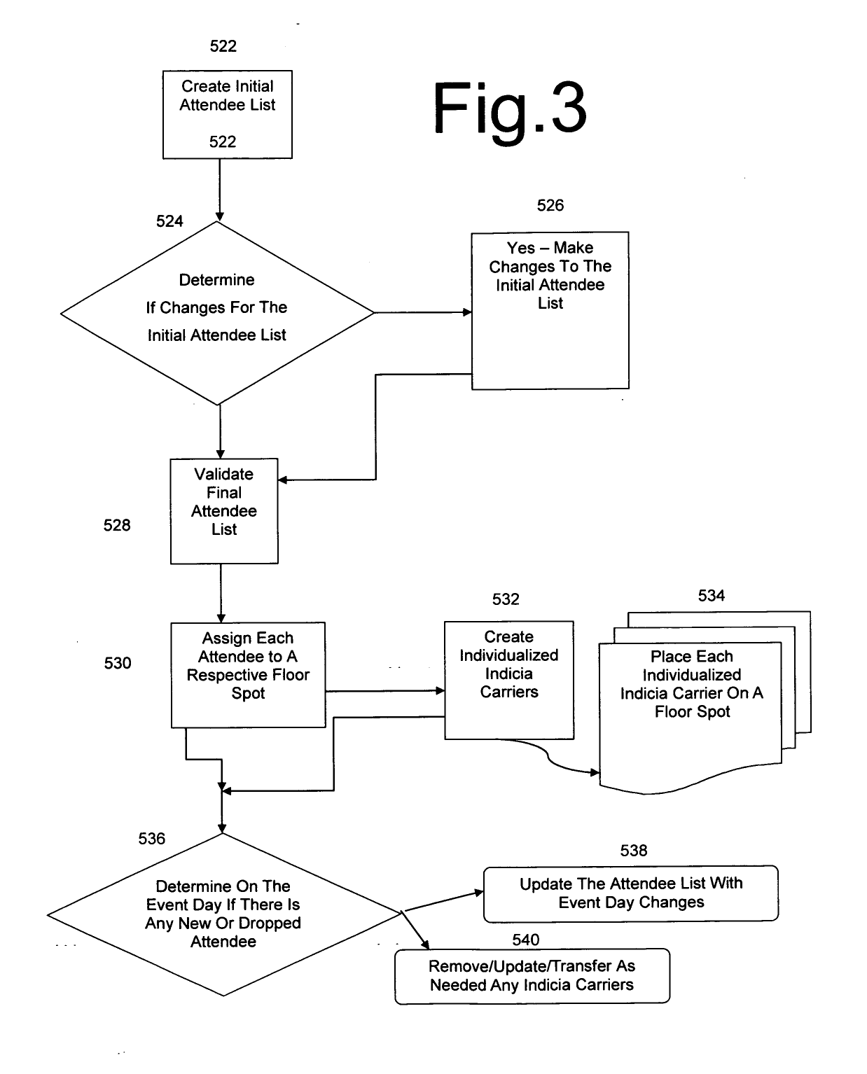

Reference is now had to FIG. 3 for a discussion of the method for coordinating a preferred occupant plan with a plurality of floor spot indicia carriers of the present invention. As seen in FIG. 3, which is a front plan schematic view of the method, the method includes several steps some of which are performed in a predetermined sequence with other steps and others of which can be performed as desired during the execution of the method. Following this discussion of the steps of the method, there will be a discussion of how the illuminated product of the present invention can be specifically adapted to optimize the smooth running of an event at which attendees are requested to sit or be located at a preferred occupancy location during the event or during a portion of the event.

Various steps of the method for coordinating a preferred occupant plan with a plurality of floor spot indicia carriers as described hereinafter can be omitted or enhanced as desired to best achieve the particular event planning goal. Referring now to FIG. 3, the method may commence with a step 522 and, with respect to this step 522, this step involves the activity of entering thename or other identifier of the preferred place occupant in an initial attendee list.

With respect to a step 524, this step involves making a determination if there is an additional attendee to add to the initial attendee list or a determination that an attendee already on the initial attendee list has in the meantime decided to no longer attend the event (i.e., a cancellation). In the event that there is an additional attendee to add to the initial attendee list or that an attendee already on the initial attendee list should be stricken from the list, then a step 526 is performed to amend the initial attendee list.

Once the initial attendee list has been amended or, alternatively, in the event that all additional attendees have been added to the initial attendee list and all canceling attendee already on the initial attendee list have been stricken from the list, then a step 528 is performed to validate the status of the initial attendee list, whereupon the initial attendee list is now operable as a list of the probable attendees of the event.

With respect to a step 530, this step involves assigning each attendee as the preferred place occupant with regard to a respective floor spot, whereupon the collective assignments of the attendees to the floor spots operates as a preferred occupant placement chart for the event. A floor spot can be, for example, a chair or a seat at a table or in a row of seats. As desired, each attendee can be assigned as the preferred place occupant with regard to a respective floor spot at any time during the period in which the initial attendee list is being created or this step can first be performed after the initial attendee list has been validated in the step 528. Additionally, in parallel with the creation of the initial attendee list, individualized indicia carriers can be created in a step 532, with each indicia carrier being individualized in that it is inscribed or otherwise formatted to bear the name of an attendee or to bear another piece of individual identifying information about the attendee.

With respect to a step 534, this step involves placing each indicia carrier that has been individualized in the step 532 on or proximate to a respective floor spot which will be occupied by a respective preferred occupant during the event. Each such indicia carrier may be disposed in its customary display position on a display stand or each indicia carrier can be placed by itself on or proximate to the respective floor spot and then the indicia carrier can be later be disposed in its customary display position on a display stand as the event draws nearer.

With respect to a step 536, this step involves making a determination if there is an additional attendee at the event who has not previously been listed on the validated attendee list or a determination that an attendee already on the initial attendee list has in the meantime decided to no longer attend the event (i.e., a cancellation). In the event that there is an additional attendee or an attendee already on the initial attendee list fails to show up at the event, then a number of steps can be optionally performed. With respect to a step 538, this step involves updating the list of attendees for the event. With respect to a step 540, this step involves undertaking certain actions with regard to specific individualized indicia carriers in the event that an attendee already on the initial attendee list fails to show up at the event or in the event that an attendee desires to change to a different floor spot than the respective floor spot that had been assigned to the attendee. Specifically, the step 540 involves undertaking these actions with regard to such individualized indicia carriers—the respective individualized indicia carrier currently on or proximate to the original floor spot is: (a) removed, (b) updated to display a different attendee, or (c) is transferred to the new different floor spot to which the attendee is now assigned.

The method for coordinating a preferred occupant plan with a plurality of floor spot indicia carriers as described with regard to FIG. 3 can be enhanced with the deployment of several variations of the interchangeable indicia carrier products of the present invention.

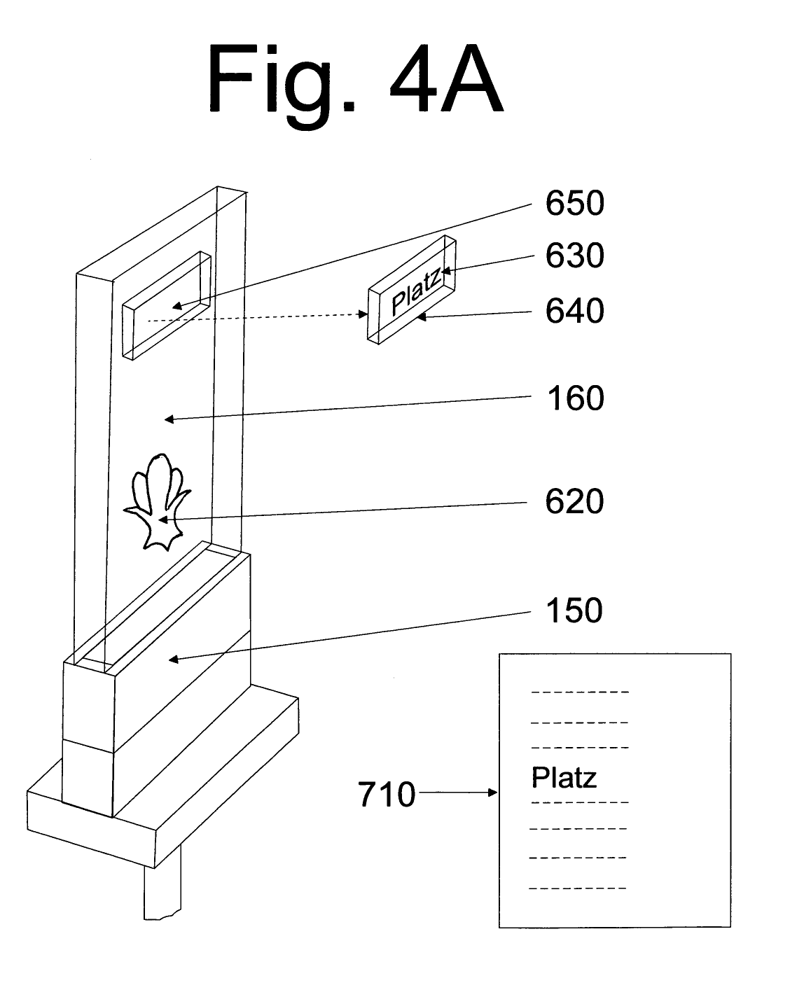

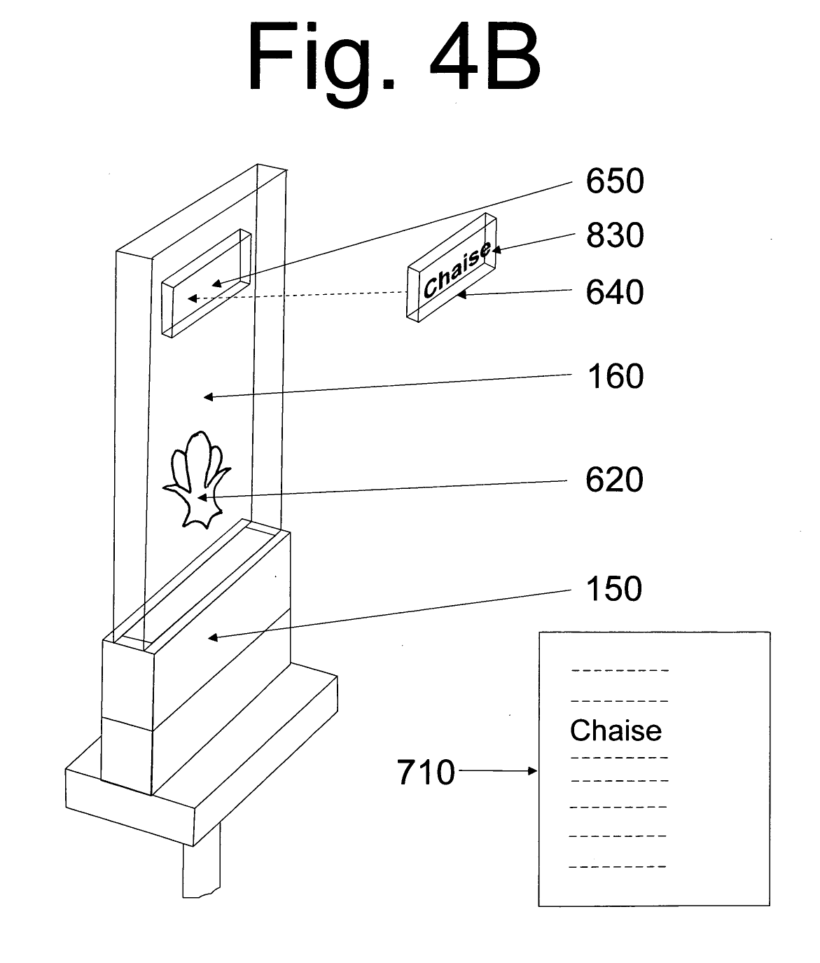

For an example of one such beneficial variation, reference is now had to FIG. 4A, which is a top perspective view of one change-out customized variation of the interchangeable indicia carrier product bearing the name of a preferred occupant, and FIG. 4B which is a top perspective view of the one change-out customized variation of the interchangeable indicia carrier product shown in FIG. 4A and bearing the name of a different preferred occupant. FIG. 4A shows the tall-remote stand product 110 that has been described with respect to FIG. 1 and it can be seen that the interchangeable indicia carrier 160 bears a graphic design 620 and an indicia 630. The indicia 630 in the form of five letters forming a family name “Platz” is configured as an acrylic plate 640 having a rectangular outer periphery and configured to be seated in a compatibly configured rectangular recess 650 formed in the interchangeable indicia carrier 160. The tall-remote stand product 110 with the interchangeable indicia carrier 160 bearing the family name “Platz” can be placed on a respective table to indicate that the preferred occupant of a respective table chair at the table is to be occupied by the guest whose family name is “Platz.” Also, a preferred occupant information item such as a validated attendee list, representatively shown as a seating chart 710, is notated to indicate that the respective table chair at the table is to be occupied by the guest whose family name is “Platz.”

In the event that the guest whose family name is “Platz” does not attend the event, requests to be assigned to a different table chair, or otherwise will not be occupying the respective table chair at the table, then, in accordance with the method of the present invention, the guest whose family name is “Platz” can be removed from the seating chart 710 or re-designated to a different seat place on the seating chart 710 and a different guest can be designated as the preferred occupant of the respective table chair at the table. In lieu of the guest whose family name is “Platz”, a newly added guest such as, for example, a newly added guest whose family name is “Chaise”, can be added to the seating chart 710 and designated as the preferred occupant of the respective table chair at the table. With regard to the tall-remote stand product 110 with the interchangeable indicia carrier 160 bearing the family name “Platz”, a different interchangeable indicia carrier 160 bearing the family name “Chaise” as indicia 830 on an acrylic plate 640 can be substituted in the recess 650 for the original interchangeable indicia carrier 160 bearing the family name “Platz.” The new interchangeable indicia carrier 160 bearing the family name “Chaise” can, if desired, bear the same graphic design 620 as the original interchangeable indicia carrier 160 bearing the family name “Platz.”

The interchangeable indicia carrier 160 can bear, in addition to the name of a preferred occupant, other helpful information such as, for example, text information about the event agenda, a personalized message from an event host or sponsor, or other event information. The interchangeable indicia carrier 160 can include a design configuration that renders the illuminated product as a whole or the indicia carrier by itself suitable as a gift to mark a special occasion or a milestone in the life of a person or an entity such as a corporation, school, or other institution or as a seasonal or holiday gift.

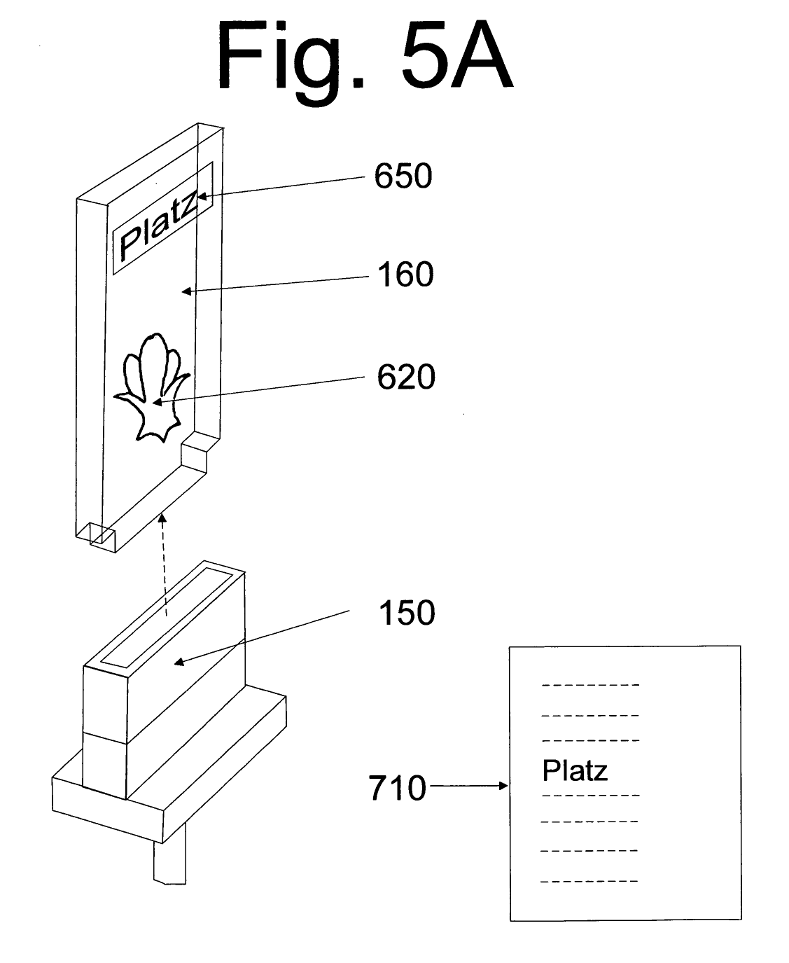

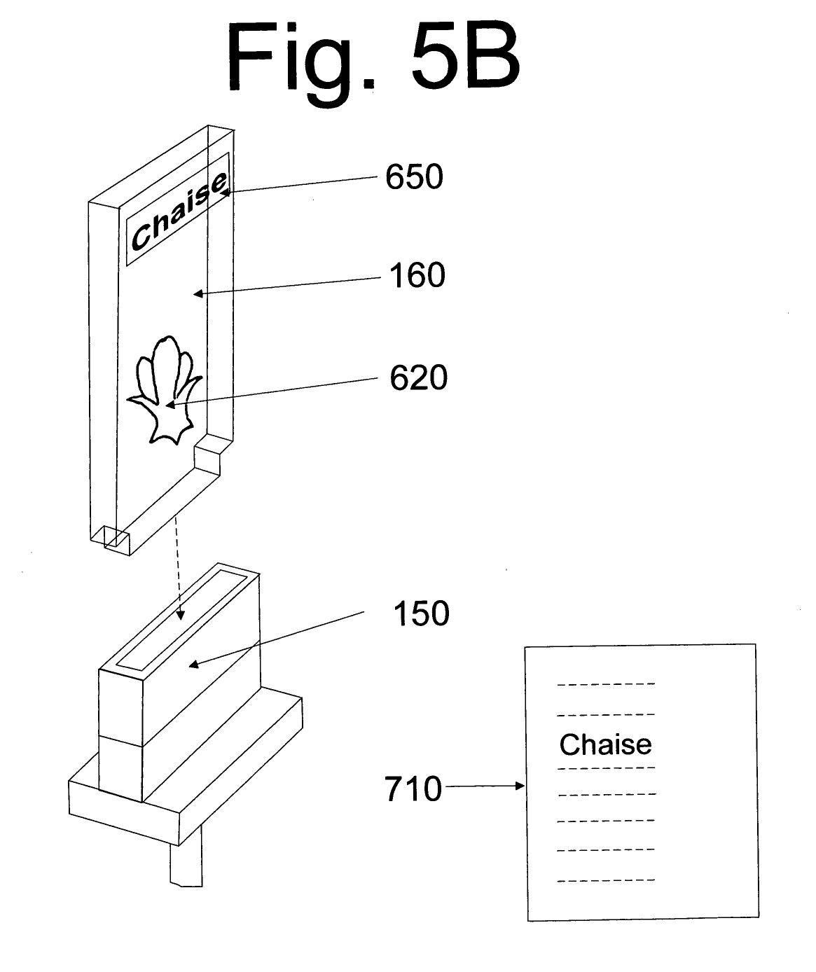

As noted, the method for coordinating a preferred occupant plan with a plurality of floor spot indicia carriers as described with regard to FIG. 3 can be enhanced with the deployment of several variations of the interchangeable indicia carrier products of the present invention and, for an example of another such beneficial variation, reference is now had to FIG. 5A, which is a top perspective view of one card swap out variation of the interchangeable indicia carrier product bearing the name of a preferred occupant, and FIG. 5B, which is a top perspective view of the card swap out variation of the interchangeable indicia carrier product shown in FIG. 5A and bearing the name of a different preferred occupant. FIG. 5A shows the tall-remote stand product 110 that has been described with respect to FIG. 1 and it can be seen that the interchangeable indicia carrier 160 bears a graphic design 620 and an indicia in the form of five letters forming a family name “Platz” is configured in a rectangular recess 650 formed in the interchangeable indicia carrier 160. The tall-remote stand product 110 with the interchangeable indicia carrier 160 bearing the family name “Platz” can be placed on a respective table to indicate that the preferred occupant of a respective table chair at the table is to be occupied by the guest whose family name is “Platz.” Also, a preferred occupant information item such as a validated attendee list, representatively shown as the seating chart 710, is notated to indicate that the respective table chair at the table is to be occupied by the guest whose family name is “Platz.”

In the event that the guest whose family name is “Platz” does not attend the event, requests to be assigned to a different table chair, or otherwise will not be occupying the respective table chair at the table, then, in accordance with the method of the present invention, the guest whose family name is “Platz” can be removed from the seating chart 710 or re-designated to a different seat place on the seating chart 710 and a different guest can be designated as the preferred occupant of the respective table chair at the table. In lieu of the guest whose family name is “Platz”, a newly added guest such as, for example, a newly added guest whose family name is “Chaise”, can be added to the seating chart 710 and designated as the preferred occupant of the respective table chair at the table. With regard to the tall-remote stand product 110 with the interchangeable indicia carrier 160 bearing the family name “Platz”, a different interchangeable indicia carrier 160 bearing the family name “Chaise” can be substituted for the original interchangeable indicia carrier 160 bearing the family name “Platz.” The new interchangeable indicia carrier 160 includes an indicia in the form of six letters forming the family name “Chaise” configured in a rectangular recess 650 formed in the interchangeable indicia carrier 160. The new interchangeable indicia carrier 160 bearing the family name “Chaise” can, if desired, bear the same graphic design 620 as the original interchangeable indicia carrier 160 bearing the family name “Platz.”

Although this invention has been disclosed and described in its preferred forms with a certain degree of particularity, it is to be realized that the optimum dimensional relationships for the parts of the invention, to include variations in size, materials, shape, form, function and manner of operation, assembly and use, are deemed readily apparent and obvious to one skilled in the art. Additionally, it is understood that the present disclosure of the preferred forms is only by way of example and that numerous changes in the details of operation and in the combination and arrangement of parts may be resorted to without departing from the spirit and scope of the invention as hereinafter claimed.

What is claimed is:

1. An illuminated product comprising:
a foot element;
a view mounting element;
a housing containing a light source;
and an interchangeable indicia carrier, the indicia carrier having a support structure, a first visual element configured to produce an illuminated effect when light emitted via the light source is incident thereon, and a second visual element, the second visual element being configured to produce a first illuminated effect, and the indicia carrier including at least one of the second visual element being configured to produce a second illuminated effect, different than its first illuminated effect, when mounted to the support structure of the indicia carrier or the second visual element being removably mounted relative to the support structure of the indicia carrier such that a third visual element can be mounted to the support structure of the indicia carrier in lieu of the second visual element.

2. The illuminated product according to claim 1 and further comprising a light delivery conduit extending between the interchangeable indicia carrier and the light source and operable to convey light emitted by the light source to a location at which light exiting the light delivery conduit is incident upon the indicia carrier.

3. The illuminated product according to claim 1, wherein the light delivery conduit is a fiber optic element.

4. The illuminated product according to claim 1, wherein the light source is a light emitting diode (LED) or other suitable light producing source.

5. The illuminated product according to claim 1, wherein the foot element is a rectangular base block having a generally planar or flat bottom surface suitable for placement into direct contact with the surface of a table, a shelf, or the like.

6. The illuminated product according to claim 1, wherein the indicia carrier is selected from the set comprising: acrylic, plastic, glass, wood, paper, cloth and other natural fibers.

7. The illuminated product according to claim 1, wherein the light source is an LED or other suitable light producing source that emits a white light or a light color other than white.

8. The illuminated product according to claim 7, wherein the light source has its intensity controlled via an integrated circuit.

9. The illuminated product according to claim 7, wherein the color appearance of the light source can be varied.

10. The illuminated product according to claim 7, wherein the color appearance of the light source can be varied via voltage frequency control.

11. The illuminated product according to claim 7, wherein the color appearance of the light source can be varied via an interchangeable colored film or gel located in the light emission path of light emitted by the light source.

12. The illuminated product according to claim 1, wherein the interchangeable indicia carrier includes a design configuration that renders the illuminated interchangeable indicia carrier product as a whole or the interchangeable indicia carrier by itself suitable as a gift to mark a special occasion or a milestone in the life of a person or an entity such as a corporation, school, or other institution or as a seasonal or holiday gift.

13. The illuminated product according to claim 1, wherein the interchangeable indicia carrier includes a design configuration that includes a seasonal image, a corporate trademark or another logo, illustration, text, graphic, relief of a photograph, or any other type of relief.

14. A method for coordinating a preferred occupant plan with a plurality of floor spot indicia carriers, the method comprising:
entering a name or other identifier of a plurality of preferred place occupants in an initial attendee list;
making a determination if there is an additional attendee to add to the initial attendee list or a determination that an attendee already on the initial attendee list has in the meantime decided to no longer attend the event;
in the event that there is an additional attendee to add to the initial attendee list or an attendee already on the initial attendee list should be stricken from the list, amending the initial attendee list to correspond to the changes;
once the initial attendee list has been amended or, alternatively, in the event that all additional attendees have been added to the initial attendee list and all canceling attendee already on the initial attendee list have been stricken from the list, validating the status of the initial attendee list, whereupon the initial attendee list is now operable as a list of the probable attendees of the event;
assigning each attendee as the preferred place occupant with regard to a respective floor spot, whereupon the collective assignments of the attendees to the floor spots operates as a preferred occupant placement chart for the event;
individualizing a plurality of indicia carriers, each indicia carrier being individualized in that it is inscribed or otherwise formatted to bear the name of an attendee or to bear another piece of individual identifying information about the attendee;
placing each indicia carrier that has been individualized on or proximate to a respective floor spot which will be occupied by a respective preferred occupant during the event;
making a determination if there is an additional attendee at the event who has not previously been listed on the validated attendee list or a determination that an attendee already on the initial attendee list has in the meantime decided to no longer attend the event and, in the event that there is an additional attendee or an attendee already on the initial attendee list fails to show up at the event, performing at least one of: (1) updating the list of attendees for the event and (2) with respect to at least one individualized indicia carrier currently on or proximate to the original floor spot is: (a) removing the at least one individualized indicia carrier, (b) updating the at least one individualized indicia carrier to display a different attendee, or (c) transferring the at least one individualized indicia carrier to the new different floor spot to which the attendee is now assigned.

15. The method for coordinating a preferred occupant plan with a plurality of floor spot indicia carriers according to claim 14, wherein at least one of the indicia carriers includes a design configuration that renders the illuminated interchangeable indicia carrier product as a whole or the interchangeable indicia carrier by itself suitable as a gift to mark a special occasion or a milestone in the life of a person or an entity such as a corporation, school, or other institution or as a seasonal or holiday gift.
